(19) United States
(12) Patent Application Publication
(10) Pub. No.: US 2005/0111158 A1
(43) Pub. Date: May 26, 2005

(54) Surge protection for electronic animal containment system

(76) Inventor: Richard L. Cohen, Novato, CA (US)

Correspondence Address: EDWARD S. SHERMAN, ESQ., 3554 ROUND BARN BLVD., SUITE 303, SANTA ROSA, CA, 95403, US

(21) Appl. No.: 10/723,327

(22) Filed: Nov. 26, 2003

(51) Int. Cl. H02H 9/06

(52) U.S. Cl. 361/119

(57) ABSTRACT

A surge protector for the transmitter of an electronic dog fence, which protector includes a direct connection to ground on one side of the antenna loop, with the signal being applied to the other side of the antenna loop.

### FIELD TO WHICH THE INVENTION RELATES

The invention of this application relates to a surge protector for an electronic containment system for animals including pets.

### BACKGROUND OF THE INVENTION

The present application is an over-voltage protection circuit for the AC power to a transmitter as well as to the loop of system.

### DESCRIPTION OF RELATED ART

FIG. 1 shows a simplified diagram of an electronic pet containment system (EPCS). The EPCS is used to keep pet dogs and other animals within or without a defined area. In an example EPCS, a low-power transmitter sends a current, typically —100 ma peak, at a set frequency of —10 kHz, to a containment loop. The containment loop itself is spread out over an area to define that area. An animal, a dog for instance, wears a collar with a small receiver sensitive to the transmitter frequency. If the dog wanders close to the containment loop wire, the field strength increases. This increasing signal in the receiver produces a warning tone, and, at higher levels (i.e., closer to the wire), a weak electric shock, to let the dog know that it is approaching a forbidden zone.

Because the loop is normally outdoors, it frequently picks up electrical surges from nearby lightning, and, in severe cases, the lightning discharge may actually attach directly to the wire of the loop. This can be the lightning current can be carried to the transmitter, and frequently the transmitter is damaged or destroyed because the lightning currents can be so large (up to hundreds of thousands of amperes). Additionally, the power supply of the containment loop is also vulnerable, as are all AC-powered appliances, to lightning or other aberrations on the AC power.

In difficult environments (installations with frequent lightning and large loops), damage may be frequent. In addition to the direct damage to the transmitter, a consequent damage is that when the dog realizes that the confining field is off, it can escape, and then may run away or be hurt.

Transient voltage surge protectors can be used for both the AC power to and the transmitter loop antenna connections of an EPCS. These surge protectors should protect the electronic circuitry of the transmitter outright from the surges on the power supply lines, and to protect the transmitter from lightning surges picked up on the containment antenna loop of the EPCS.

Examples of the surge protectors include the surge protector set forth in Dix U.S. Pat. No. 4,996,945. In this Dix protector, the inventors only describe protection against lightning impulses picked up on the loop, and ignore the problem of surges on the AC supply.

A more sophisticated design is shown in the Panamax Model M2DF. The Panamax M2DF provides for AC protection as well as loop protection, and integrates both protectors in a single housing.

The surge protectors for the antenna loop in these two devices are relatively similar in that they use gas tubes to connect any surges on either side of the antenna loops to ground, while using solid-state protectors (zener diodes, transorbs, or sidactors) to limit voltage between the two sides of the antenna loop, and limit voltages between the antenna lines and ground. Excessive voltages between the two loop wires or between either loop wire and ground can result in damage to the transmitter.

FIG. 6 shows how the M2DF or other integrated Loop+AC protectors are connected between the loop and the transmitter terminals, and between the AC power source and the power supply, to intercept surges that come from either source. A protector of this type is frequently called a “Multi-Port Protector.”

The design intent of this type of multi-port protector is to intercept the surges and conduct them to the AC ground terminal.

In the Panamax M2DF, a separate AC protector and antenna loop protector are connected together in a single housing in order to utilize the advantages of a close ground. This protects the transmitter better than separate AC and loop protectors, because, during lightning strike conditions, differences in the effective ground potential between the AC protector ground and the signal protector ground are minimized. This “Multi-Port” type of protection thus has advantages over a separate stand-alone loop signal protector circuit such as that disclosed in Dix.

In these prior devices, if the AC (power outlet) ground is missing or ineffective, lightning surges coming in on the loop wires will be conducted, via the loop protector, and then the AC protector, to the AC power wires (line and neutral). The transmitter will still be protected, but this is a less effective and less desirable operation mode than having a good ground connection.

### OBJECTS OF THE INVENTION

It is an object of this invention to provide surge protection for both the AC-powered supply and the transmitter of an EPCS;

It is another object of this invention to provide for a surge protector combining AC and transmitter protectors with a minimum number of components;

It is a further object of this invention to increase the capacity of surge protection provided for an EPCS;

It is still a further object of this invention to improve the quality of antenna loop protection for the transmitter of an EPCS;

It is yet another object of this invention to ameliorate damages from high voltage surges in an EPCS;

It is a further object of this invention to reduce the cost of an EPCS surge protector;

It is still a further object of this invention to reduce the number of components in surge protectors for an EPCS; and, other objects and a further understanding of the invention may be had by referring to the detailed description of the invention:

### BRIEF DESCRIPTION OF THE DRAWINGS

FIG. 1 is a block diagram of an integrated surge protector,

FIG. 2 is a Block diagram like FIG. 1 of a surge protector incorporating the invention,

FIG. 3 is a schematic diagram of an integrated transmitter and antenna surge protector built according to the invention;

FIG. 4 is another circuit incorporating the invention;

FIG. 5 is a further circuit incorporating the invention; and,

FIG. 6 is a circuit diagram of the Panamax M2DF surge protector for a pet containment system.

### DETAILED DESCRIPTION OF THE INVENTION

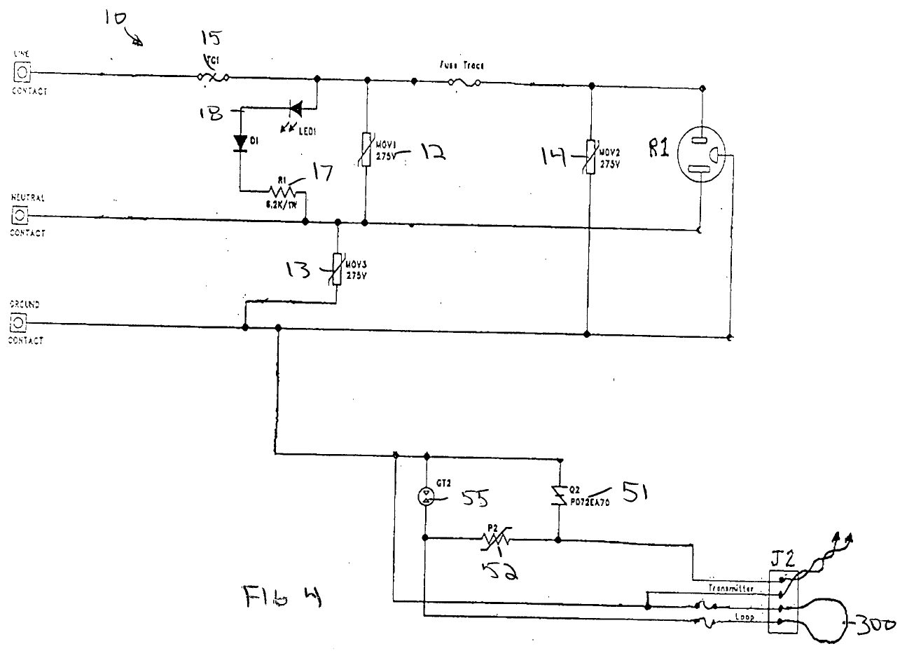

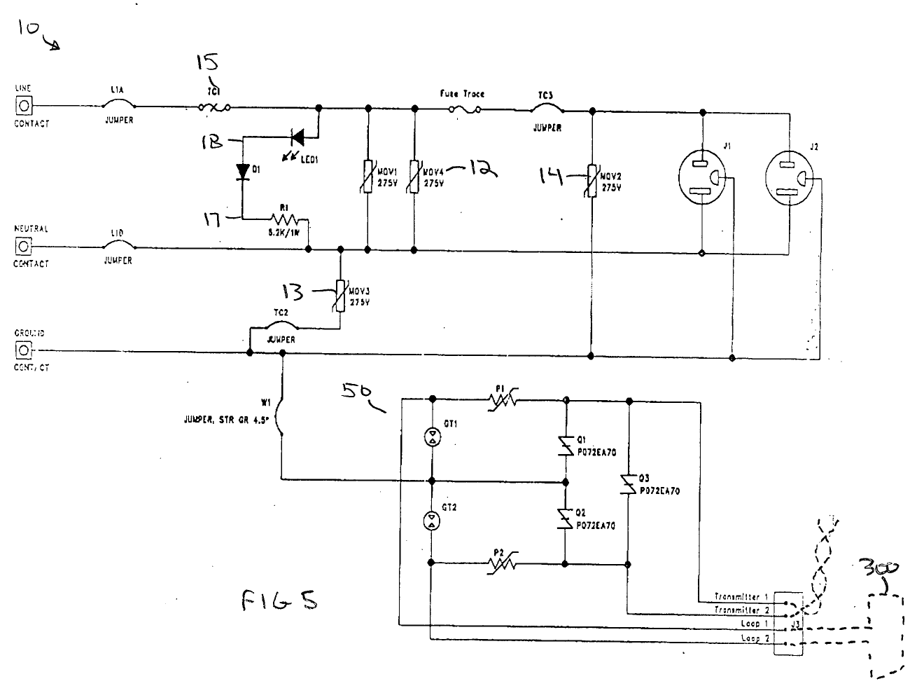

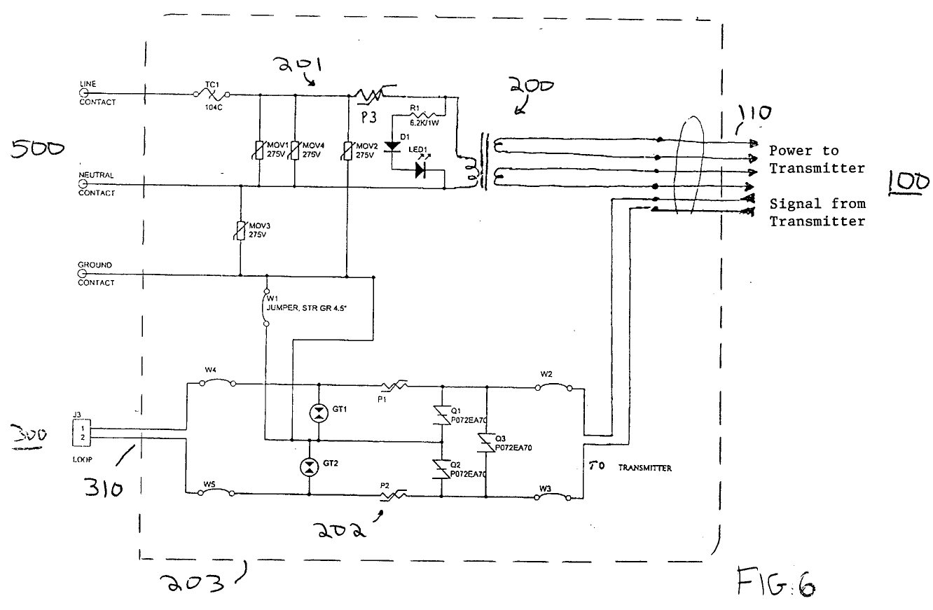

The invention of this application relates to an improved surge protector for a loop antenna EPCS. An example prior art protector, the M2DF is shown in FIG. 6. This type of protector, with the loops outdoors, is vulnerable to current surges from lightning, which can be carried in on the loop wire and damage the transmitter. For complete protection, a surge protector must be used on the loop, and another protector is required to stop transients coming from the AC power source. In the M2DF and in the new design (FIG. 3), both protectors are mounted in the same housing, and their ground terminals interconnected.

The protector of the present application includes a transmitter 100, a source of power for the transmitter 200, a loop antenna 300 and a pet receiver 400. The transmitter provides a signal, which travels through the antenna 300 for activation of the animal/pet receiver. This signal is typically a high frequency signal such as a 10,000 kHz broadcast signal. The transmitter 100 itself is interconnected via a power supply to a source of power 200, normally the house mains of alternating current, in order to provide the power necessary for the transmitter 100 to energize the loop antenna 300.

After training, the animal is typically released within the confines of the loop antenna 300 to recognize the warning signals applied to the animal by the receiver 400 when such receiver comes into proximity with the antenna loop 300. A number of organizations use the flags and a series or preconditioning exercises in order to train the pet that the limits defined by the antenna 300 should be respected. This training enables the animal to recognize the warning signals put out by the receiver, (typically an escalating and annoying noise followed by shocks) and thus to precondition the animal to avoid the areas defined by the loop antenna 300. (By routing the loop antenna 300 around an area, the animal can be confined therein.) Note that the containment system can operate to exclude an animal from the area defined by the containment loop, and/or a multiplicity of loops can cooperate to define with some precision the preferred area (in some, without others). Utilization of multiple frequency collars would facilitate this additional control.

The containment system in the preferred embodiment is reliable and has stood the test of time, particularly for dogs and their confinement within the limits of their property. System reliability is very important, since if the system becomes inoperative, the dog will eventually realize this and may escape, with strong adverse consequences.

A common cause of system failure is lightning damage to the transmitter. To prevent this damage, many different surge protector designs have been used.

Certain systems, such as that previously set forth in Dix U.S. Pat. No. 4,996,945, provide protection for the loop antenna 300 in order to protect the system. Other systems, such as the Panamax system, also include an integrated AC protector in order to provide protection between the transmitter 100 and its source of power 200 in addition to between the loop antenna 300 and the transmitter 100.

These protector circuits for the containment system heretofore have been balanced systems in that they provide 2-terminal symmetrical protection for both wires of the transmitter-antenna loop connection. This causes both wires of the transmitter 100 and loop antenna 300 to be isolated from the ground when there is no surge voltage present. These systems thus protect each transmitter terminal separately to protect the transmitter. The protector accomplishes this protection for both terminals of the antenna side of the transmitter. While this provides effective protection of the transmitter against surges which may come in from the loop antenna circuit, the protector requires seven separate components. Further, the maximum impulse, which can be suppressed, is limited by the capability of the gas tubes, which provide the main surge protection to ground.

The present invention relates to the improved protection circuit, which not only integrates the AC power protector with an electronic loop protector, but, in addition, does so with a minimum number of components. In the preferred embodiment shown, this integration is accomplished by using a single-wire protection circuit, with the other loop wire being directly grounded to the internal ground of the multi-port protector, which further preferred, is in turn connected to the electrical system (green wire) ground (FIG. 3) of the house. The protector design applies protection (surge limiting) to only 1 loop wire, in contrast with previous designs having both wires with voltage/current limiting components installed.

The circuit begins with a surge protector 10 for the AC power for the transmitter 100. The particular AC power protection circuit disclosed includes line-to-neutral, neutral-to-ground, and line-to-ground metal oxide varistors 12, 13, 14 in combination with a thermal fuse 15. In the particular embodiment disclosed, a separate resistor/diode circuit 17/18 indicates the fact that the surge protection in functioning and the power is being provided to the transmitter 100.

Included in this AC power protection system is a ground connection 20 of relatively large cross-sectional area, to withstand large lightning surges. This ground connection 20 is preferably as short as possible in order to reduce the impedance of the interconnection to ground to a minimum value.

In addition to an AC protection circuit, the preferred embodiment of the invention also includes a loop antenna protection circuit 50. This circuitry is unique for this application in having only a single terminal, and in its minimum number of components.

In the typical 2-wire animal containment system protectors (the Dix or Panamax devices, previously set forth, for example), the loop antenna 300 is isolated from ground. This allows each side of the loop antenna to float differentially in respect to the other side of the loop antenna while both float separately in respect to any ground. These symmetrical protector systems have a larger number of components. Part of this is because each side of the antenna loop must be separately protected relative to ground. Further, the protector must limit not only voltages between the terminal wires and ground, but between the two terminal wires.

In contrast to the above, the protector circuit of the present invention has electronic protection for only one wire/terminal. This simplification is provided by grounding one side of the antenna loop at the protector with a low impedance electrical path. This grounding accomplishes two purposes: 1) it prevents surges from coming in along the grounded loop wire, since surge currents are carried away by the ground, and 2) it can remove surge currents up to the burnout capacity of the ground jumper wire in the protector, typically —40 KA. This is much greater than the typical capacity of a loop surge protector, <20 KA.

The preferred system protector design applies protection (surge limiting) to only one loop wire in contrast with previous designs having both wires with voltage/current limiting components installed. Since the preferred system is inherently isolated from electrical ground, it is possible to ground directly (to the house wiring) one loop termination and one transmitter connection. This approach decreases the number of components required for complete protection, and allows a smaller and less expensive housing. The subject of this application is a protector that has protection for only one loop wire, and effectively grounds the other wire. The invention also provides, optionally, for connection to the transmitter by means of an attached two-conductor cable. The cable eliminates the need for two terminals on the terminal strip, and simplifies installation.

The first purpose of the preferred system protector design is that it accomplishes is to allow the system to absorb essentially unlimited surges on one half of the antenna loop. The reason for this is the straight interconnection between the antenna loop 300 and ground 30 (i.e., there are no intermediate components in this connection). This allows the resistance between the antenna loop 300 and ground 30 to be as close to zero as possible (within the limits of the ground connection). The surge current capacity of the lesser of the antenna loop 300 and the protector 10 is the limiting factor. The design of the system thus immediately provides protection against a higher level of surges than the more traditional balanced loop system.

The second purpose of the preferred protector design is in respect to the minimum number of components. In specific, the majority of the surge protection is provided by a single gas tube between one side of the antenna loop 300 and the ground. This paradoxically provides better protection for the antenna loop 30 by allowing the more expeditious routing of a voltage surge on the antenna loop directly to ground through this single component. This protection is thus better in a single component than the seven or eight components provided in the previously discussed Dix and Panamax devices.

Further, the single gas tube is utilized to protect the loop with two separate components (a sidactor 51 and resistance 52 shown) allowing for the passage of the control signal from the transmitter 100 to the antenna loop 300. The three components on the antenna loop protection circuit 50 thus cooperate with each other to provide for a solid level of protection for the ungrounded section of the loop with a minimum number of components. The loop-to-ground protection is through a single gas tube 40. This minimizes the resistance of the protector for this connection. Further, this same ground provides a low resistance for the grounded loop terminal. This in contrast with, for example, the Panamax M2DF design which utilizes seven components.

The preferred protection circuit 50 of the above-entitled invention thus provides for a solid measure of protection for voltage surges and swings on the antenna loop 300 with a minimum number of components.

Although the invention is described in its preferred embodiment with a certain degree of particularity, it is realized that numerous changes may be made without deviating from the invention as hereinafter claimed.

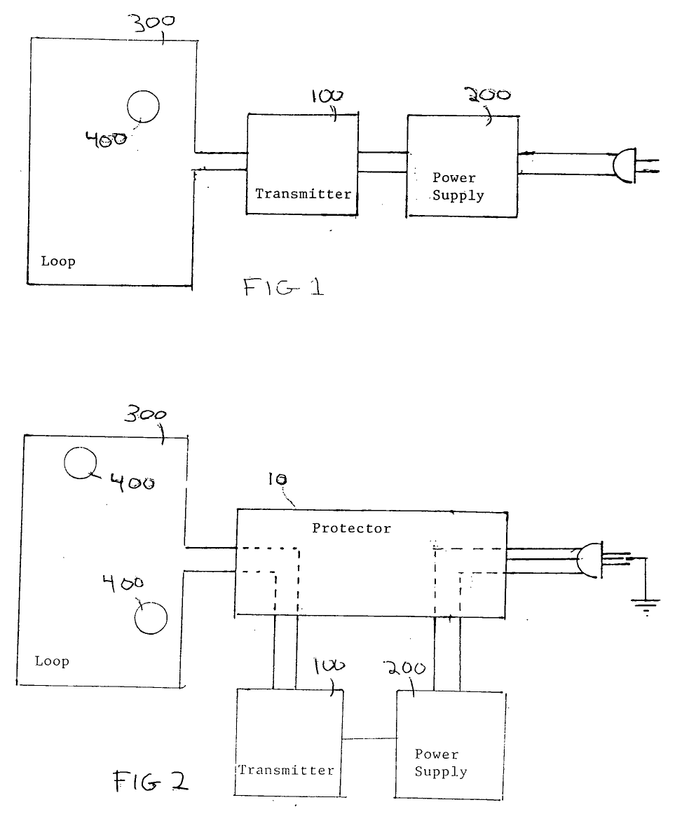

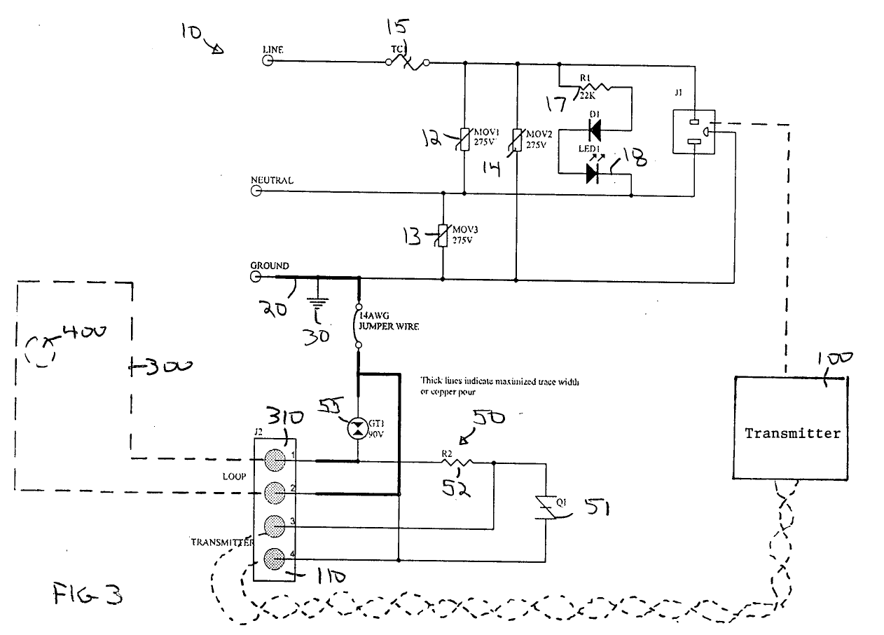

For example, the inventive design includes two different options for the connections to the transmitter. In the preferred implementation, an attached cable provides connections between the loop protector and the transmitter (FIG. 1). In an alternate design, a terminal strip, with individual wire connections, is used to connect between the protector and the transmitter (FIG. 2). The components at the top of the figures comprise the AC protector, feeding receptacle Ri, intended to provide protected AC power for the transmitter.

1. An electronic impulse circuit for a device having a power circuit having a line, neutral and ground, a transmitter having outputs to a loop antenna having two inputs,
the electronic impulse circuit comprising:
a) a power impulse protection circuit interconnecting power circuit line and neutral to power circuit ground;
b) a loop impulse protection circuit interconnecting one input of the loop antenna to said antenna ground together with;
c) a heavy ground interconnecting said power circuit ground and said loop antenna ground.

2. The impulse circuit of claim 1 characterized in that the heavy ground is connected to an earthed ground.

3. The impulse circuit of claim 1 characterized in that the impulse protection for the loop antenna is on a printed circuit board with a maximized trace width for such impulse protection.

4. The impulse circuit of claim 1 characterized in that the heavy ground is for the one input of the loop antenna is on a printed circuit with a maximized trace width.

5. The impulse circuit of claim 3 characterized in that the heavy ground is for the one input of the loop antenna is on a printed circuit with a maximized trace width.

6. The impulse circuit of claim 3 characterized in that the heavy ground interconnection to one input of the loop antenna includes a 1-2 inch length of from 16-12 gauge wire.

7. The impulse circuit of claim 6 characterized 16-12 gauge wire also forms part of the impulse protection circuit for one input of the loop antenna.

8. The impulse circuit of claim 1 characterized in that the impulse protection circuit the one input of the loop antenna includes a gas tube bridging the one input of the loop antenna to the heavy ground.

9. The impulse circuit of claim 8 characterized in that the impulse protection circuit of the output of the transmitter includes a resistance to the gas tube.

10. The impulse circuit of claim 9 characterized in that the impulse protection circuit for the output of the transmitter includes the resistance.

11. An electronic impulse circuit for a device having a power circuit having a line, neutral and ground, a transmitter having two output terminals and a loop antenna having two inputs,
the electronic impulse circuit comprising:
a) an impulse protection circuit interconnecting power circuit line and neutral to power circuit ground;
b) an impulse protection circuit interconnecting one output of the transmitter to power circuit ground;
c) an impulse protection circuit interconnecting one input of the loop antenna to power circuit ground together with;
d) a heavy ground interconnecting power circuit ground and one output of the transmitter and one input of the loop antenna.

12. The impulse circuit of claim 11 characterized in that the heavy ground is connected to an earthed ground.

13. The impulse circuit of claim 11 characterized in that the impulse protection for the loop antenna is on a printed circuit board with a maximized trace width for such impulse protection.

14. The impulse circuit of claim 1 characterized in that the heavy ground for the one input of the loop antenna is on a printed circuit with a maximized trace width.

15. The impulse circuit of claim 13 characterized in that the heavy ground for the one input of the loop antenna is on a printed circuit with a maximized trace width.

16. The impulse circuit of claim 13 characterized in that the heavy ground interconnection to one input of the loop antenna includes a 1-2 inch length of from 18-10 gauge wire.

17. The impulse circuit of claim 16 characterized 18-10 gauge wire also forms part of the impulse protection circuit for one input of the loop antenna.

18. The impulse circuit of claim 11 characterized in that the impulse protection circuit the one input of the loop antenna includes a gas tube bridging the one input of the loop antenna to the heavy ground.

19. The impulse circuit of claim 18 characterized in that the impulse protection circuit of the output of the transmitter includes a resistance to the gas tube.

20. The impulse circuit of claim 19 characterized in that the impulse protection circuit for the output of the transmitter includes the resistance.
